(19) United States
(12) Patent Application Publication
(10) Pub. No.: US 2002/0090930 A1
(43) Pub. Date: Jul. 11, 2002

(54) Entrance administration equipment and system thereof

(76) Inventors: Tsuyoshi Fujiwara, Kyoto (JP); Yuji Taketoshi, Kyoto (JP); Amehiko Iki, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 10/014,585

(22) Filed: Dec. 14, 2001

(30) Foreign Application Priority Data
Dec. 14, 2000 (JP) 2000-379793

(51) Int. Cl. H04M 1/66

(52) U.S. Cl. 455/410; 455/411; 380/247

(57) ABSTRACT

When entrance administration equipment detects an approaching user, it transmits a communication trigger command to a portable telephone, carried by the approaching user. When it receives a response signal from the portable telephone, it transmits a transmitting command of embarkation person information. When it receives the person's embarkation information from the portable telephone, it executes an authentication process. When the person's embarkation information does not coincide with data of the embarkation-scheduled person database, the entrance administration equipment displays a message of a failure of the authentication process. When the authentication process succeeds, the entrance administration equipment records the person's embarkation information, opens the door, issues a printed ticket containing the person's embarkation information, and transmits a control signal for turning off power of the portable telephone to the portable telephone.

### CROSS-REFERENCE TO RELATED APPLICATIONS

Japanese Patent Application 379793/2000, filed Dec. 14, 2000.

### BACKGROUND OF THE INVENTION

Recently, a multifunctional portable telephone reserves seat tickets for a train, an airplane or a music concert. The multifunctional portable telephone stores the reservation information and seat information, instead of tickets made of paper. The stored information is used for processing entrance or confirming the reserved seat.

In addition, the number of users of portable telephones is increasing rapidly, and the use of portable telephones in unfavorable locations is a recent social problem.

For example, the use of a portable telephone in a movie theater or a train disturbs those around the portable telephone. Additionally, the use of a portable telephone close to an electrical instrument may cause it to malfunction.

Accordingly, there have been various systems proposed limiting the use of portable telephones in locations where the use of such portable telephones is unfavorable.

For example, there has been a system proposed in which any operation of a portable phone is disabled when the phone receives a radio wave transmitted from a device installed in a train or a bus. The portable phone is enabled as a user carrying the portable phone leaves the train or the bus as the radio wave no longer reaches the portable telephone.

There has been proposed another system in which a pair of devices is installed in a predetermined area to limit the use of a portable telephone. A condition of the portable phone switches between ‘enable to call’ or ‘disable to call’ according to the order of receiving a radio wave transmitted from each of the devices.

Moreover, there has been proposed still another system, in which a condition of the portable phone switches between ‘enable to receive’ or ‘disable to receive’ according to a switching signal transmitted from equipment installed in the entrance of an area where the use of the portable phone is limited,

Also, there has been proposed still another system in which a call of a portable phone is limited by receiving a control signal transmitted from an entrance wicket of a railway station but communication by pager transmission mode is enabled.

In the above proposed systems, a portable telephone is designed to control to cut power of the portable phone (turned to a ‘power off’ state) when a user enters into a predetermined location by passing the location where a control device for controlling power of the portable telephone is installed. However, the user has to turn on the power of the portable phone again in order to confirm the stored information such as reserved seat information of a train or an airplane after entry.

### BRIEF SUMMARY OF THE INVENTION

It is a primary object of this invention to provide a system in which a portable communication terminal represented by a portable telephone is used for entrance administration in an embarkation entrance of an airport, a wicket of railway, or an entrance of a concert hall or a movie theater. Power of the portable communication terminal is automatically controlled in a location where the use of the portable communication terminal is limited. Then, the information necessary after turning off, or deactivating the power of, the portable communication terminal can be printed on a media such as a predetermined paper without having to refer to the stored information of the portable communication terminal.

According to a first aspect of this invention, there is provided an entrance administration equipment which includes a first transmitter for transmitting a transmission command of first information representing visitor information to a portable communication terminal, a receiver for receiving the first information from the portable communication terminal, a determining unit for determining based on the first information received by the receiver whether or not a user carrying the portable communication terminal is allowed to enter, a printer for printing second information on a predetermined media based on the first information received by the receiver when the determining unit determines that the user is allowed to enter, and a second transmitter for transmitting to the portable communication terminal a control signal for cutting or deactivating power of the portable communication terminal.

The portable communication terminal communicates with other equipment such as a portable telephone, a PDA (Personal Digital (Data) Assistants) or the like.

For example, the first transmitter, the receiver and the second transmitter are represented by a short-range communication unit. The first transmitter, the receiver and the second transmitter may transmit and receive information by employing an electromagnetic wave or by electrical contact.

The first information received by the receiver includes the information for determining in the entrance administration equipment whether or not a person (user) owning the portable communication terminal is allowed to enter, and the information for identifying the portable communication terminal. For instance, when the entrance administration equipment is installed in an embarkation entrance of an airport, the entrance administration equipment receives information such as a reservation identification, an airline company name, a flight number, a seat number, an embarking person's full name, a scheduled departure time of day, and a scheduled arrival time of day of a person scheduled to embark, as the first information.

The determining unit determines based on the received first information whether or not a user holding a portable communication terminal is allowed to enter inside of the embarkation entrance of the airport where the entrance administration equipment is installed. In other words, the determining unit determines whether or not an embarkation ticket of an airplane is purchased and its corresponding electronic information is stored in the portable communication terminal. For example, the determining unit may be represented by an authentication unit. Also, the portable communication terminal may be represented by an portable telephone.

The printer prints the second information on a predetermined media for a user who is allowed to enter by the determining unit. The predetermined media may employ any media on which information can be printed, such as a predetermined size of paper, a plastic card or the like. For example, the printer may be represented by a ticket issuer.

The second information printed by the printer may include an airline company name, a flight number, a seat number, an embarking person's full name, a departure secure time of day, and a scheduled arrival time of day, whereby, for example, a ticket is produced.

For example, the entrance administration equipment is installed in an embarkation entrance of an airport, a wicket of a railway, or an entrance of a concert hall or a movie theater.

In the entrance administration equipment according to the first aspect of this invention, the transmission command of the first information representing visitor information is transmitted to the portable communication terminal. Then the first information is received from the portable communication terminal. Then it is determined based on the received first information whether or not the user carrying the portable communication terminal is allowed to enter. Then the second information is printed on the predetermined media based on the received first information when it is determined that the user is allowed to enter. Then the control signal for cutting power of the portable communication terminal is transmitted to the portable communication terminal.

Therefore, at the location where the portable communication terminal is used for an entrance administration and the user of the portable communication terminal is limited, the power of the portable communication terminal is automatically controlled, thereby limiting the disruption of others and preventing emission of radio waves that may cause the malfunction of electrical or other precision instruments. Furthermore, the information necessary after power deactivation of the portable communication terminal is printed on the media such as predetermined paper, so that the user is not required to activate the power of the portable communication terminal again for referring to the information.

In addition, the second information may include the information necessary after cutting the power of the portable communication terminal which is included in the first information.

The first information includes a reservation's identification, an airline company name, a flight number, a seat number, an embarking person's full name, a scheduled departure time of day, a scheduled arrival time of day, and so on, of a person scheduled to embark or passenger. For example, the information necessary after cutting or deactivating the power of the portable communication terminal includes the seat number and the scheduled arrival time of day to be confirmed when the passenger seats. However, the reservation identification is not necessary to be referred by the passenger, and it is conceivable that reference to an airline company name is not necessary inside of an embarkation entrance where the embarkation entrance is isolated for each airline company.

Since the second information includes information in the first information that is necessary after cutting the power of the portable communication terminal, all of the received first information is not printed but only the second information necessary for the passenger is printed, thereby minimizing the size of the media made of paper or the like.

The first information and the second information may include the seat number.

The seat number in an airplane is not necessary in order to process entrance operations at the embarkation entrance, but is necessary for the passenger to enter the embarkation entrance and take the reserved seat in the airplane for confirmation. By including a seat number in the first and second information, the seat number can be written on the media to be printed (for example, a ticket), thereby providing passengers with convenient service.

The predetermined media may employ a predetermined media made of paper.

In addition, there can be provided a notifying unit for notifying that a passenger or user is not allowed to enter. The notifying unit may display a message such that the user is not allowed to enter, whereby the user is notified that entrance of the user is not allowed. For example, the notifying unit may be represented by a display unit which displays the message, such as ‘PLEASE VERIFY YOUR ENTRANCE GATE’, ‘PLEASE RETURN TO AN AISLE ATTENDED BY A PERSON IN CHARGE’ and the like on, when the user is not allowed to enter, thereby notifying the user that entrance of the user is not allowed.

The notifying unit may be designed to produce a voice signal indicating that the user is not allowed to enter, whereby the user is notified that entrance is not allowed. The voice signal for notifying that the user is not allowed to enter can include a voice message, such as ‘PLEASE VERIFY YOUR ENTRANCE GATE’, ‘PLEASE RETURN TO AN AISLE ATTENDED BY A PERSON IN CHARGE’, and the like, in addition to buzzer or alarm. When a user is not allowed to enter, the notifying unit may be designed to notify by activating or deactivating a predetermined LED indicating that the user is not allowed to enter. LEDs of different colors may also be illuminated indicating whether the user is allowed to enter or not.

Employment of a notifying unit can provide a user or an entrance managing administrator with comprehensive notice such as whether a user going past the entrance administration equipment is allowed to enter or not.

Further, there may be provided a controlling unit for controlling opening and closing of a predetermined device to limit the passage of users, which controls opening and closing of the predetermined device based on results of the determination by the determining unit. For example, the controlling unit may be represented by a door driver unit. The predetermined device for limiting the passage of users may be represented by a door at the entrance.

When it is determined that a user going past the entrance administration equipment is not allowed to enter, the door driver unit closes the door so that the user cannot enter. When it is determined that the user is allowed to enter, the door driver unit opens the door so that the user can enter. Thus, passage of users can be limited based on the results of the determination whether or not a user can enter.

The entrance administration equipment may further include a storing unit for storing information with respect to a user who is allowed to enter, in which the determining unit can refer to information with respect to the user stored by the storing unit and determine whether or not the user carrying the portable communication terminal is allowed to enter.

For example, the storing unit may be represented by an embarkation-scheduled person database unit. The information with respect to a user who is allowed to enter may be represented by a person's embarkation information of a reservation identification of an embarkation-scheduled person or passenger. An authentication unit can determine whether or not a user who holds a portable communication terminal is allowed to enter by determining whether or not the inputted person's embarkation information coincides with information stored in the embarkation-scheduled person database unit. Accordingly, it can be determined by referring to information stored beforehand whether or not a user who holds a portable communication terminal is allowed to enter.

The entrance administration equipment may further include a recording unit for recording the information of the user who is determined to be able to enter by the determining unit. For example, the recording unit may be represented by a visitors recording unit. The user's embarkation information which is authenticated by the authentication unit to be able to enter inside of the embarkation entrance of the airport where the entrance administration equipment is installed is recorded in the visitors recording unit. By recording the information about the user determined to be able to enter, the users who have entered inside can be confirmed. For example, it can be confirmed whether or not an embarkation procedure of all embarkation scheduled persons is finished.

According to a second aspect of this invention, there is provided an entrance administration equipment which includes a first transmitter for transmitting a transmission command of first information representing visitor information to a communication terminal, a receiver for receiving the first information from the portable communication terminal, a determining unit for determining based on the first information received by the receiver whether or not a user carrying the portable communication terminal is allowed to enter, a printer for printing second information on a predetermined media based on the first information received by the receiver when the determining unit determines that the user is allowed to enter, and a second transmitter for transmitting to the portable communication terminal a control signal for cutting or deactivating power of a communication function of the portable communication terminal.

The portable communication terminal is a terminal, which can communicate with other equipment such as a portable telephone, a PDA (Personal Digital (Data) Assistants) or the like.

For example, the first transmitter, the receiver and the second transmitter may be represented by a short-range communication unit. The first transmitter, the receiver and the second transmitter may transmit and receive information with electromagnetic waves or by electrical contact.

The first information received by the receiver includes the information for determining in the entrance administration equipment whether or not a user owning the portable communication terminal is allowed to enter, and the information for identifying the portable communication terminal. For instance, when the entrance administration equipment is installed in an embarkation entrance to an airport, the entrance administration equipment receives information as the first information, such as a reservation identification, an airline company name, a flight number, a seat number, an embarking person's full name, a scheduled departure time of day, and a scheduled arrival time of day of a person scheduled to embark.

For example, the determining unit may be represented by an authentication unit. The determining unit determines, based on the received first information, whether or not the user holding the portable communication terminal such as the portable telephone can enter inside of the embarkation entrance of the airport where the entrance administration equipment is installed. In other words, the determining unit determines whether or not an embankment ticket of an airplane is purchased and its corresponding electronic information is stored in the portable communication terminal.

For example, the printer may be represented by a ticket issuer. The printer prints the second information on a predetermined media for a user who is determined by the determining unit to be allowed to enter. The predetermined media may employ any media on which information can be printed, such as a predetermined size of a paper, a plastic card or the like. The second information printed by the printer may include an airline company name, a flight number, a seat number, an embarking person's full name, a scheduled departure time of day, and a scheduled arrival time of day, whereby, for example, a ticket is made.

For example, the entrance administration equipment including these components is installed in an embarkation entrance of an airport, a wicket of a railway, or an entrance of a concert hall or a movie theater.

The second transmitter produces a control signal to be transmitted to the portable communication terminal for cutting power of a communication function in the functions employed in the portable communication terminal.

In the entrance administration equipment according to the second aspect of this invention, the transmission command of the first information representing visitor information is transmitted to the portable communications terminal, the first information is received from the communication terminal, then it is determined based on the received first information whether or not the user carrying the portable communication terminal is allowed to enter. The second information is printed on the predetermined media based on the received first information when it is determined that the user is allowed to enter. The, the control signal for cutting power of the communication function of the portable communication terminal is transmitted to the portable communication terminal.

Therefore, the power of the communication function of the portable communication terminal at the location where the use of the portable communication terminal is limited is automatically controlled, thereby limiting the disruption of others and preventing emission of radio waves that may cause the malfunction of electrical or other precision instruments while other functions of the portable communication terminal would remain active. Furthermore, the information necessary after power deactivation of the portable communication terminal is printed on a media, such as a predetermined paper, so that the user does not need to activate the power of the portable communication terminal again for referring to this information.

An entrance administration system according to this invention includes an entrance administration equipment and a portable communication terminal. The entrance administration equipment includes a first transmitter for transmitting a transmission command of first information representing visitor information to the communication terminal, a first receiver for receiving the first information from the portable communication terminal, a determining unit for determining based on the first information received by the first receiving unit whether or not the user carrying the portable communication terminal is allowed to enter, a printer for printing a second information on a predetermined media based on the first information received by the first receiving unit when the determining unit determines that the user is allowed to enter, and a second transmitter for transmitting to the portable communication terminal a control signal for cutting power of the portable communication terminal. The portable communication terminal includes a storing unit for storing the first information, a second receiver for receiving a transmission command of the first information stored in the storing unit from the entrance administration equipment, a third transmitter for transmitting the first information stored in the storing unit, a third receiver for receiving the control signal for controlling the power from the entrance administration equipment, and a controller for controlling the power based on the control signal received by the third receiver.

The portable communication terminal communicates with other equipment such as a portable telephone, a PDA (Personal Digital (Data) Assistants) or the like.

For example, the first transmitter, the first receiver and the second transmitter may be represented by a short-range communication unit. The first transmitter, the first receiver and the second transmitter may transmit and receive information by electromagnetic waves or by electrical contact.

The first information received by the first receiver includes, for example, a reservation identification, an airline company name, a flight number, a seat number, a seat number, an embarking person's full name, a scheduled departure time of day, and a scheduled arrival time of day of a person scheduled to embark.

For example, the determining unit may be represented by an authentication unit. The determining unit determines based on the received first information whether or not the user holding the portable communication terminal such as the portable telephone is allowed to enter inside of the embarkation entrance of the airport where the entrance administration equipment is installed. In other words, the determining unit determines whether an embarkation ticket of an airplane is purchased and its corresponding electronic information is stored in the portable communication terminal.

For example, the printer may be represented by a ticket issuer. The printer prints the second information on a predetermined media for a user who is allowed by the determining unit to enter. The predetermined media may employ any media on which information can be printed, such as a predetermined size of paper, a plastic card or the like.

The second information printed by the printer may include an airline company name, a flight number, a seat number, an embarking person's full name, a scheduled departure time of day, and a scheduled arrival time of day, whereby, for example, a ticket is made.

For example, the entrance administration equipment provided with these components is installed in an embarkation entrance of an airport, a wicket of a railway, or an entrance of a concert hall or a movie theater.

For example, the storing unit is represented by a storage section. The storage section stores therein the first information including a reservation identification, an airline company name a flight number, a seat number, and embarking person's full name, a scheduled departure time of day, a scheduled arrival time of day of a person scheduled to embark, to be transmitted to the entrance administration equipment, if desired.

For example, the second receiver, the third transmitter and the third receiver may be represented by a short-range communication unit. The short-range communication unit receives a transmission command of the first information stored in the storing unit from the entrance administration equipment and transmits the first information stored in the storing unit, and receives a control signal for controlling power from the entrance administration equipment.

The controller, for example, is represented by a power supply control unit. The power supply control unit controls the power of a portable communication terminal's call unit based on the control signal received by the short-range communications unit.

In the entrance administration system according to this invention, the entrance administration equipment transmits a transmission command of the first information representing visitor information to the portable communication terminal, receives the first information to determine based, on the received first information. whether or not the user carrying the portable communication terminal is allowed to enter. When it is determined that the user is allowed to enter, the entrance administration equipment prints the second information on the predetermined media based on the received first information, and transmits to the portable communication terminal the control signal for cutting power of the portable communication terminal. The portable communication terminal stores the first information therein, receives the transmission command of the stored first information, transmits the first information, receives the control signal for controlling power, and controls the power based on the received control signal.

Therefore, at the location where the portable communication terminal is used for an entrance administration and the use of the portable communication terminal is limited, the power of the portable communication terminal is automatically controlled, thereby limiting the disruption of others and preventing emission of radio waves that may cause the malfunction of electrical or other precision instruments. Furthermore, the information necessary after power deactivation of the portable communication terminal is transmitted from the portable communication terminal to the entrance administration equipment, and printed on a media such as a predetermined paper in the entrance administration equipment, so that the user does not need to activate the power of the portable communication terminal again for the referring to this information.

### BRIEF DESCRIPTION OF THE DRAWINGS

FIG. 1 is a perspective view of an entrance administration system according to a preferred embodiment of this invention;

FIG. 2 is a block diagram showing an internal construction of an entrance administration equipment employed in the system of FIG. 1;

FIG. 3 is a block diagram showing a construction of a short-range communication unit employed in the equipment of FIG. 2;

FIG. 4 shows an example of a ticket issued from the entrance administration equipment of FIG. 1;

FIG. 5 is a block diagram showing an internal construction of a portable telephone employed in the system of FIG. 1;

FIG. 6 shows a flow chart for operation of the entrance administration equipment; and

FIG. 7 is a flow chart for operation of the portable telephone.

### DETAILED DESCRIPTION OF THE INVENTION

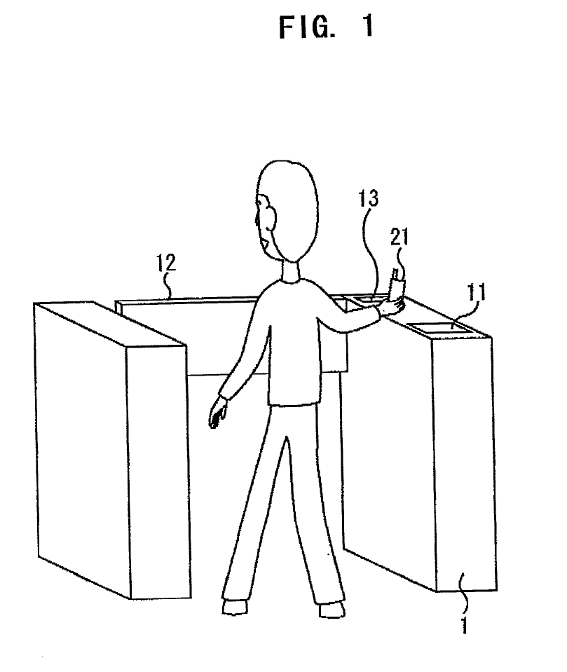

FIG. 1 depicts and entrance administration system according to a preferred embodiment of this invention, which includes an entrance administration equipment 1 and a portable telephone 21.

The entrance administration equipment 1 may be installed at an embarkation entrance of an airplane, a wicket of a station, and entrance of a movie theater or a concert hall, or the like, to execute an entrance procedure. In this embodiment, the entrance administration equipment 1 is installed at an embarkation entrance of an airplane.

When a user or passenger enters the entrance installed the entrance administration equipment 1 to remain in an area administrated thereby, the passenger brings the portable telephone 21 close to a short-range communication unit 11 disposed on an upper wall of the entrance administration equipment 1 to communicate with the entrance administration equipment 1 for transmitting embarkation person information stored in the portable telephone 21 to the entrance administration equipment, thereby executing an entrance procedure.

In FIG. 1, the location in which the passenger stands is an aisle. As a door 12 opens, the passenger can pass through the aisle to enter into an appointment area.

Furthermore, as the passenger enters through the embarkation entrance, the entrance administration equipment 1 transmits a control signal to control power supply of a the entire portable telephone 21, or a part of the portable telephone executing a call function thereof, to limit speaking over the portable telephone 21.

When the above described entrance procedure is finished, the entrance administration equipment 1 transmits a control signal for disconnecting (power off) power of the portable telephone 21 from the short range communication unit 11. Then the portable telephone 21 turns off its power supply upon receiving the control signal.

Furthermore, the entrance administration equipment 1 prints the information such as a seat number necessary after power off on a media of a card type to be issued from a ticket issuer 13.

The ticket issuer 13 is disposed at a back, or near the exit of the aisle, formed by the entrance administration equipment 1. The short-range communication unit 11 is a disposed near an entry to the aisle. The passenger goes to the back from a front, or entry, side of the aisle, whereby communication between the short-range communication unit 11 of entrance administration equipment 1 and the portable telephone 21 is carried out at the entry of the aisle. Then a ticket is issued near the exit of the aisle from the ticket issuer 13. Therefore, the passenger goes smoothly through the aisle made by the entrance administration equipment 1.

Thus, in an entrance area, such as the entrance area to an airplane, where a telephone call with the portable telephone 21 is undesirable, the power supply of the portable telephone 21 is controlled to limit its use, thereby limiting the disruption of others and preventing emission of radio waves that may cause the malfunction of electrical or other precision instruments. Moreover, information such as a seat number, necessary after cutting the power supply of the portable telephone 21, is printed, so that the power of the portable telephone 21 is not necessary to be reactivated in order to confirm the seat number.

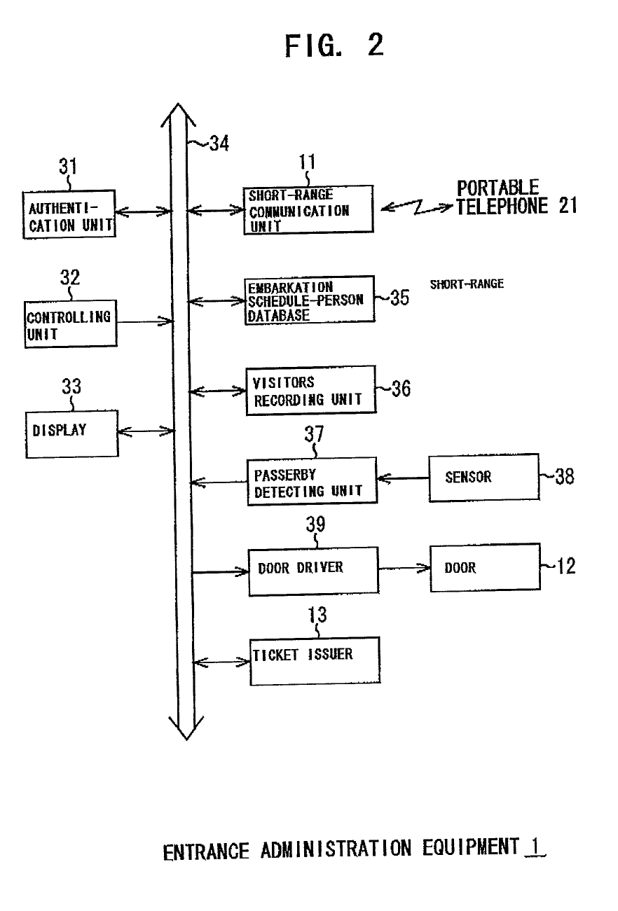

FIG. 2 is a block diagram showing an example of an internal construction of the entrance administration equipment 1. The parts corresponding to those in FIG. 1 are given the same reference symbols, and its explanation is omitted for simplification.

A controlling unit 32 controls each unit of the entrance administration equipment 1. The controlling unit 32 makes an order for transmitting embarkation person information to the portable telephone 21 to be transmitted to the portable telephone 21 through a bus 34 and short-range communication unit 11, and outputs the embarkation person information entered through the short-range communication unit 11 to be applied to an authentication unit 31 through the bus 34. Upon receiving an input of an authentication result showing that the passenger is person scheduled to embark from the authentication unit 31, the controlling unit 32 further generates a control signal for cutting, or turning off, the power supply of the portable telephone 21 held by the passenger to be transmitted to the portable telephone 21 held by the passenger to be transmitted to the portable telephone 21 through the bus 34. Then the controlling unit 32 outputs the person's embarkation information to be applied to visitors recording unit 36 and ticket issuer 13 through the bus 34.

An authentication unit 31 refers to a person's scheduled to embark information recorded in an embarkation-scheduled person database 35 on the basis of the embarkation person information inputted by the controlling unit 32 through the bus 34. The authentication unit 31 executes an authentication process to determine whether or not the passenger who is going to enter is actually the person scheduled to embark. Then the authentication unit 31 outputs an authentication result to be applied to controlling unit 32 and door driver 39 through bus 34.

For example, a display 33 employs an LCD (Liquid Crystal Display). The display 33 is disposed on the same wall (the top wall of the entrance administration equipment 1) as the wall disposed by the short-range communication unit 11 of FIG. 1. The display 33 displays various messages (such at ‘PLEASE VERIFY YOUR ENTRANCE GATE’, ‘PLEASE RETURN TO AN AISLE ATTENDED BY A PERSON IN CHARGE’ and the like) to the passenger based on the authentication result produced by authentication unit 31 through bus 34.

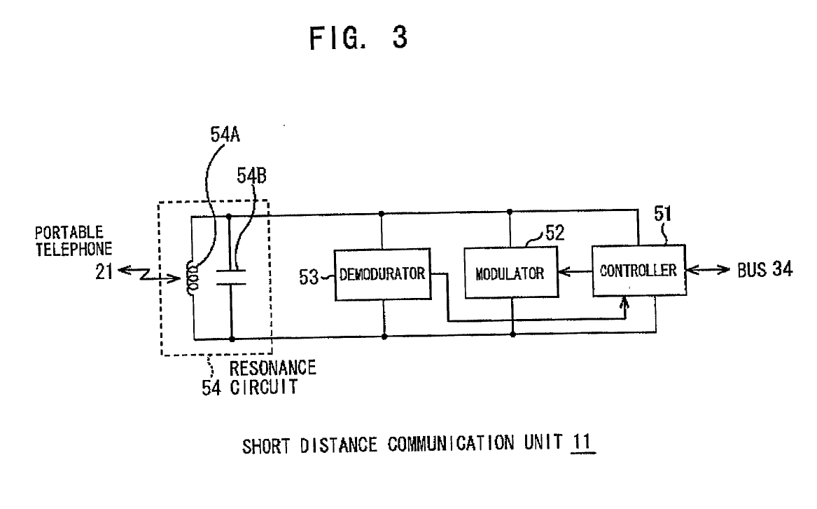

The short-range communication unit 11 produces an electromagnetic wave to communicate with the portable telephone 21. FIG. 3 is a block diagram showing a detailed construction of the short-range communication unit 11.

The short-range communication unit 11 includes a controller 51, a modulator 52, a demodulator 53 and a resonance circuit 54 consisting of a coil 54A and a capacitor 54B.

The controller 51 controls the operation of the short-range communication unit 11 based on the signal entered by the controlling unit 32 through the bus 34. Also Controller 51 applies the information entered by the demodulator 53 to the controlling unit 32 through the bus 34.

The modulator 52 modulates a signal entered by the controller 51 to be supplied to the resonance circuit 54 for emitting an electromagnetic wave to the portable telephone 21 from the coil 54A.

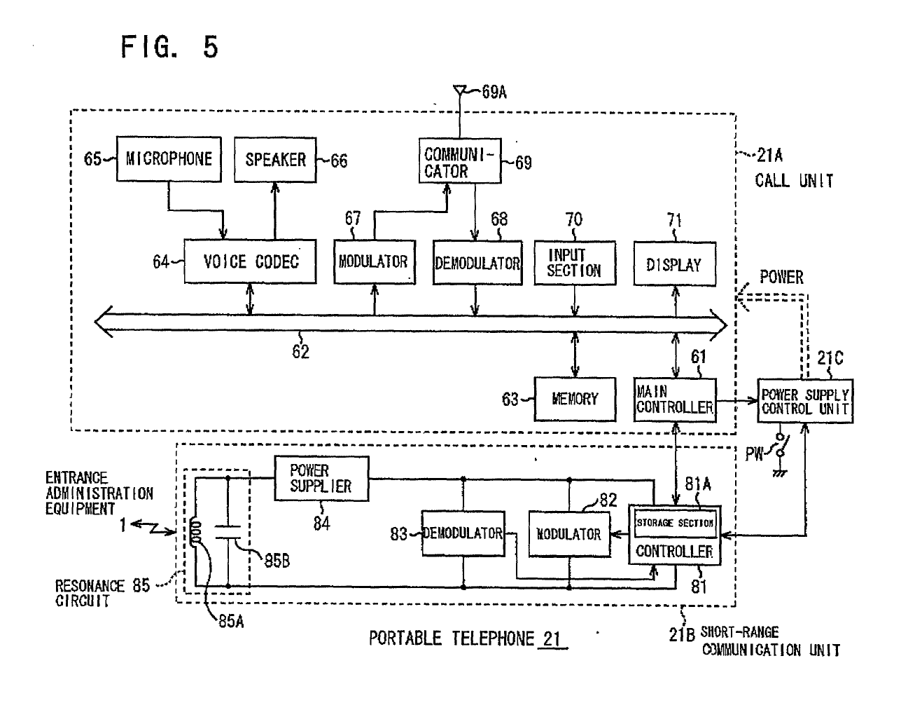

The demodulator 53 demodulates an electromagnetic wave which is transmitted from a short-range communication unit 21B of the portable telephone 21 (see FIG. 5 described later) and received by the coil 54A serving as an antenna, and applies the demodulated signal to the controller 51.

The resonance circuit 54 is regulated by the coil 54A and the capacitor 54B, and executes resonance at a predetermined resonance frequency to transmit and receive various information by unit of electromagnetic waves communication with the short-range communication unit 21B of the portable telephone 21.

The embarkation-scheduled person database 35 records therein a person's embarkation information such as reservation identifications of embarkation-scheduled person. The recorded information is read out by the authentication unit 31 upon requirement. The visitors recording unit 36 receives embarkation information of the passenger whose authentication is complete from the controlling unit 32 through the bus 34, and records the embarkation person information. The embarkation-scheduled person database 35 and the visitors recording unit 36 may be represented by an external device disposed outside of the entrance administration equipment 1, if desired.

A passerby detecting unit 37 detects based on a signal produced from a sensor 38 whether or not there exists a passenger near the entrance administration equipment 1, and applies the results of the determination to the door driver 39 through the bus 34.

The door driver 39 controls opening and closing of the door 12 based on the authentication result applied by the authentication unit 31 and the result of the determination entered by the passerby detecting unit 37.

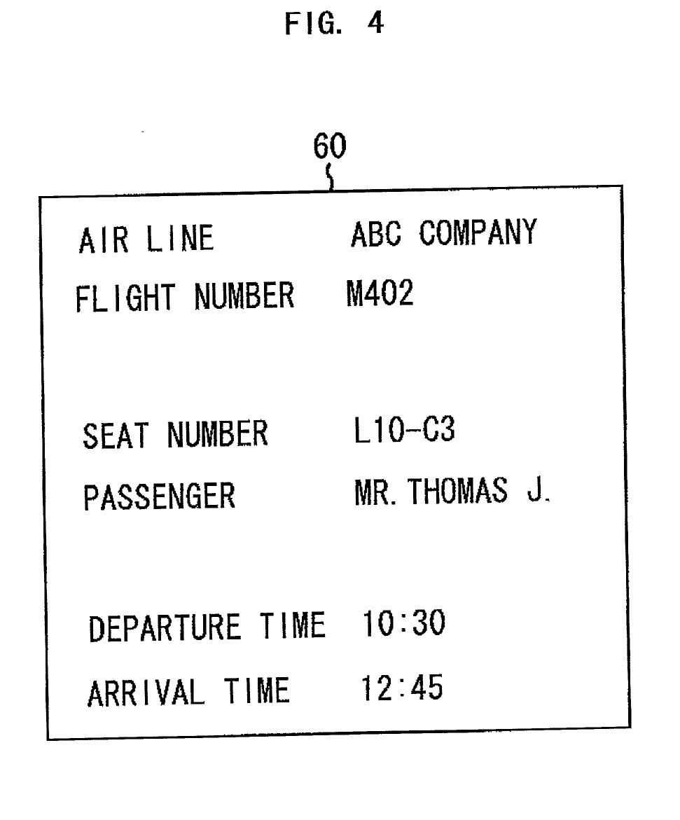

The ticket issuer 13, for example, includes a paper tray for accommodating predetermined papers to be printed with information such as seat numbers, which is necessary after cutting power of the portable telephone 21, a paper conveyance section for conveying papers from the paper tray, and a printer section for printing predetermined information on the papers conveyed from the paper conveyance section. The ticket issuer 13 prints the information necessary after cutting the power of the portable telephone 21 on predetermined paper based on the embarkation person information input by the controlling unit 32, and outputs the printed paper. A ticket 60 output by the ticket issuer 13 is shown in FIG. 4. The ticket 60 may utilize a single face or both faces for printing and is printed with an airline company name, a flight number, a seat number, an embarking person's full name, scheduled departure time of day, arrival schedule time of day, and so on.

FIG. 5 is a block diagram, which shows an example of internal construction of the portable telephone 21.

The portable telephone 21 includes a call unit 21A for carrying out an original communication function of a portable telephone, short-range communication unit 21B for carrying out an communication function with the entrance administration equipment 1, and a power supply control unit 21C. The call unit 21A carries out various processes in a voice call transmission mode and a data communication mode.

A main controller 61 includes a CPU (Central Processing Unit), a ROM (Read Only Memory), and a RAM (Random Access Memory), and controls the respective components connection with a bus 62 in a voice call transmission mode and a data communication mode.

A memory 63 employs a nonvolatile flash memory, and stores various information therein. For example, telephone numbers of other telephones entered through an input section 70 by a user of the portable telephone 21 are administrated and stored as a telephone book. The memory 63 stores mail that has been transmitted and received in data communication mode.

A voice CODEC 64 encodes in a predetermined formula an analog audio signal of a voice collected by microphone 65 in the voice call mode to be converted into digital sound data. In addition, the voice CODEC 64 decodes in a predetermined formula the digital sound data supplied by a demodulator 68 to be converted into an analog audio signal for application to a speaker 66 to generate a voice.

A modulator 67 executes a spread spectrum process of the supplied digital data, and applies the executed digital data to a communicator 69. For example, the modulator 67 in the voice call mode executes a spread spectrum process of the voice data supplied from the voice CODEC 64 to be supplied to the communicator 69. The modulator 67 in the data communication mode executes a spread spectrum process of the text data entered from the input section 70 to be supplied to the communicator 69.

The communicator 69 executes a digital to analog conversion process and a frequency conversion process with the digital data supplied from modulator 67 to be transmitted to the nearest base station (not shown in drawings) through the antenna 69A.

In addition, the communicator 69 executes a frequency conversion process and an analog to digital conversion process about the signal received by the antenna 69A, and applies the converted digital data to the demodulator 68.

The demodulator 68 executes a reverse spread spectrum process with the digital data supplied from the communicator 69 to be supplied to the respective sections. For example, the demodulator 68 in the voice call mode supplies the digital data produced by executing the reverse spread spectrum process to the voice CODEC 64. The demodulator 68 supplies the obtained text data to a display 71 in the data communication mode.

The input section 70 is represented by a numerical keypad or various kinds of switch buttons, and is operated by a user.

The display 71 is represented by an LCD or the like, and displays characters and images corresponding to the various supplied various data.

When a portable telephone 21 is near the short-range communication unit 11 of the entrance administration equipment 1, the short-range communication unit 21B communicates with the short-range communication unit 11.

The short-range communication unit 21B has a similar construction to that of the short-range communication unit 11 (FIG. 3) of the entrance administration equipment 1. The short-range communication unit 21B includes a controller 81, a modulator 82, a demodulator 83, and a resonance circuit 85 consisting of a coil 85A and a capacitor 85B. These components have same functions as those of the controller 51, the modulator 52, and demodulator 53 and the resonance circuit 54 in the short-range communication unit 11, and its explanation is omitted for simplification. The controller 81, however, includes a storage section 81A consisting of a flash memory built therein.

The storage section 81A stores therein a person's embarkation information such as a reservation identification assigned to a passenger when reserving an aviation ticket—an airline company name, a flight number, a seat number, an embarkation person name, and the scheduled departure time or the scheduled arrival time, which are reserved. The person's embarkation information is received from a web site administrated by an airline company or other agents through a network such as an internet where an aviation ticket is reserved by using the portable telephone 21, and entered into the main controller 61 to be stored therein.

The short-range communication unit 21B further includes a power supplier 84. The power supplier 84 supplies controller 81, modulator 82 and demodulator 83 with power generated by receiving the electromagnetic wave transmitted from the short-range communication unit 11 of the entrance administration equipment 1 to activate controller 81, modulator 82 and demodulator 83.

Accordingly, the entrance administration equipment 1 can drive the controller 81 by transmitting the electromagnetic wave to the portable telephone 21 in the circumstance that the portable telephone 21 cut off its power supply or is deactivated.

A power supply control unit 21C supplies electric power from a built-in battery pack when a power button PW is turned ON activating the call unit 21A.

The power supply control unit 21C controls the power supply to the call unit 21A by changing the power button PW between ON and OFF according to a command from the short-range communication unit 21B (controller 81). For example, when a control signal designating that the power is to be cut (deactivate or turn to OFF) is transmitted from the short-range communication unit 11 of the entrance administration equipment 1, the controller 81 of the short-range communication unit 21B instructs the power supply control unit 21C to cease its supply to the call unit 21A (deactivate call).

When the portable telephone 21 includes functions (data processing functions such as a word processing function or an image processing function) which are different from the communication function, the power supply control unit 21C can be designed to cut (or deactivate) the entire power of the portable telephone 21, or the power of one of the functions (for example, only the power for the call unit 21A is cut (or deactivated) but the power for other functions is not cut), based on the command from the short-range communication unit 21B (controller 81).

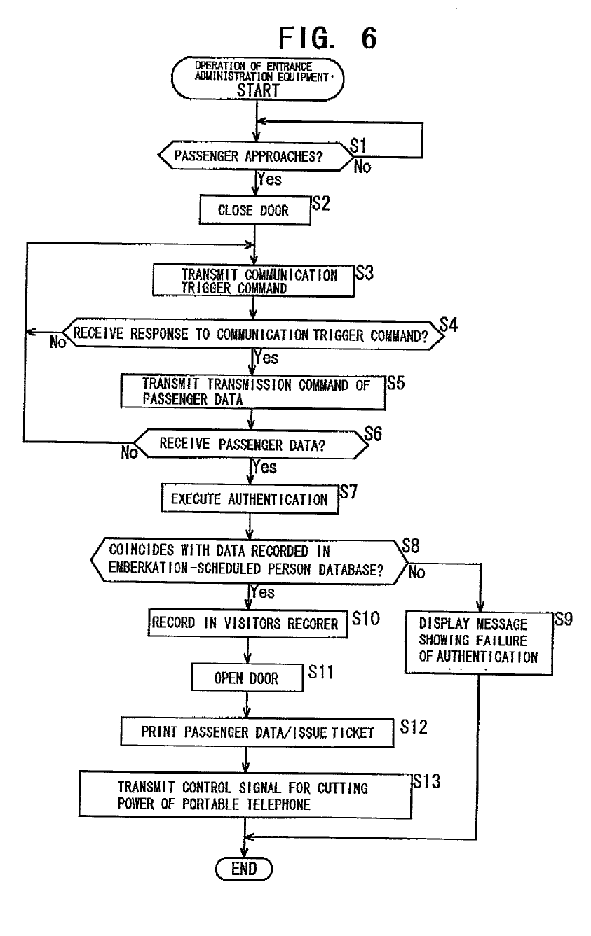

Referring to a flow chart shown in FIG. 6, an operation executed by the entrance administration equipment 1 will be described hereinafter.

In a step S1, the controlling unit 32 of the entrance administration equipment 1 determines if a passenger approaches on the basis of a signal supplied by the passerby detecting unit 37 through the bus 34. When it is determined in the step S1 that no passenger is approaching, the sequence of the step S1 will be repeated until any passenger is determined to approach.

When it is determined that the passenger approaches in the step S1, the controlling unit 32 generates control signal for closing the door 12 to be applied to the door driver 39 through the bus 34 in a step S2. The door driver 39 closes the door 12 according to the applied control signal.

In a step S3, the controlling unit 32 generates a control signal for transmitting a communication trigger command to be applied to the short-range communication unit 11. The controller 51 of the short-range communication unit 11 controls the modulator 52 in correspondence with the command applied from the controlling unit 32 to constantly (cyclically at predetermined intervals (for example, interval of several milliseconds) which are short enough in comparison with the movement of a person) transmit the communication trigger command by employing an electromagnetic wave of a predetermined frequency from the resonance circuit 54. The controlling unit 32 waits until it receives a response from the portable telephone 21.

As the passenger brings the portable telephone 21 close to the short-range communication unit 11, the resonance circuit 85 of the portable telephone 21 detects an electromagnetic wave from the coil 54A of the short-range communication unit 11 to output the detection signal to the demodulator 83. The demodulator 83 demodulates the detection signal to apply a result of the modulation to the controller 81. Then, the controller 81 controls the modulator 82 to modulate a response signal. The response signal is transmitted from the coil 85A of the resonance circuit 85 to the short-range communication unit 11.

Upon receiving an electromagnetic wave corresponding to the response signal from the portable telephone 21, the resonance circuit 54 of the short-range communication unit 11 applies the detected signal to the demodulator 53 to be demodulated. Upon receiving an input of a demodulated signal from the demodulator 53, the controller 51 applies its corresponding response signal to the controlling unit 32 through the bus 34.

In a step S4, the controlling unit 32 determines on the basis of signal entered from the short-range communication unit 11 through bus 34 whether or not the response signal corresponding to the communication trigger command is received. When it is determined that no response signal is received in the step S4, the sequence returns to the step S3, and its subsequent sequence is repeated.

When it is determined that the response signal is received in the step S4, the controlling unit 32 generates a transmission command of embarkation person information to be transmitted to the portable telephone 21 through the bus 34 and the short-range communication unit 11 in a step S5.

In a step S6, the controlling unit 32 determines on the basis of a signal entered from the short-range communication unit 11 through the bus 34 whether or not embarkation person information is received. When it is determined that no embarkation person information is not received in the step S6, the sequence returns to the step S3, and its subsequent sequence is repeated.

When it is determined that embarkation person information is received in the step S6, the controlling unit 32 outputs the received embarkation person information to be applied to the authentication unit 31 in a step S7. The authentication unit 31 carries out an authentication process on the basis of the embarkation person information entered from the controlling unit 32.

In a step S8, the authentication unit 31 determines whether the entered embarkation person information coincides with data recorded in the embarkation-scheduled person database 35.

When it is determined that the entered input embarkation person information does not coincide with the data recorded in the embarkation-scheduled person database 35 in the step S8, the authentication unit 31 outputs a signal representing a failure of authentication to be applied the controlling unit 32 in step a S9. Then, the controlling unit 32 generates a control signal for making the display 33 display a message showing the failure of authentication to be applied to the display 33. According to the control signal, the display 33 displays a message showing the failure of authentication (for example, ‘PLEASE VERIFY YOUR ENTRANCE GATE’ and ‘PLEASE RETURN TO AN AISLE ATTENDED BY A PERSON IN CHARGE’). Then the operation ends.

The display 33 of this embodiment displaying a picture message showing the failure of authentication may be modified by employing a speaker in the entrance administration equipment 1 which outputs an alarm sound or a voice message indicating the failure of authentication ‘PLEASE VERIFY YOUR ENTRANCE GATE’ and ‘PLEASE RETURN TO AN AISLE ATTENDED BY A PERSON IN CHARGE’. Also, the display 33 may be modified by employing an LED in the entrance administration equipment 1 which is activated when the authentication fails. Also, the display 33 may be modified by transmitting a signal representing an error message to the portable telephone 21 through the bus 34 and the short-range communication unit 11 to display the error message on the display 71 of the portable telephone 21.

Activation of the LED shows that the passenger going to pass is not allowed to enter. If desired, however, there may be employed a predetermined LED that is activated when the authentication is carried out correctly and deactivated when the authentication has failed, or different color LEDs which are respectively activated indicating that the passenger is allowed to enter or not allowed to enter.

When it is determined that the embarkation person information received from the portable telephone 21 coincides with data recorded in the embarkation-scheduled person database 35 in the step 88, the authentication unit 31 outputs a signal representing that the authentication is to be normally processed to be applied to the controlling unit 32. The controlling unit 32 generates a control signal for making the visitors recording unit 36 record embarkation person information thereon to be applied to the visitors recording unit 36. The visitors recording unit 36 records the embarkation person information according to the outputted control signal.

In a step S11, the authentication unit 31 outputs a signal representing that the authentication is normally processed, to be applied to the door driver 39. The door driver 39 opens the door 12 in order to allow the passenger to enter.

In a step S12, the controlling unit 32 outputs the embarkation person information to be applied to the ticket issuer 13 through the bus 34. The ticket issuer 13 prints the embarkation person information on a predetermined paper to issue the ticket 60 shown in FIG. 4.

In a step S13, the controlling unit 32 generates a control signal for cutting power supply of the portable telephone 21 to be transmitted to the portable telephone 21 through the bus 34 and the short-range communication unit 11. Once this is completed, the operation ends.

When the portable telephone 21 has a different function other than the communicator function, the controlling unit 32 may be modified to generate a control signal for cutting the power supply of the call function of the portable telephone 21 to be transmitted to the portable telephone 21 through the bus 34 and the short-range communication unit 11.

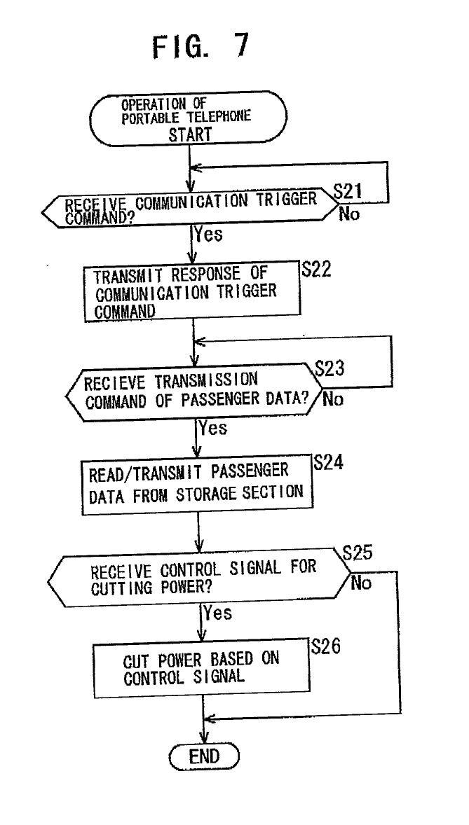

Next, an operation of the portable telephone 21 will be described hereinafter referring to a flow chart shown in FIG. 7. The operation of the portable telephone 21 is executed concurrently with the operation of the entrance administration equipment 1 explained referring to FIG. 6,

In a step S21, the controller 81 determines on the basis of a signal entered through the resonance circuit 85 and the demodulator 83 whether the communication trigger command transmitted by the entrance administration equipment 1 in the step S3 of FIG. 6 is received or not. When it is determined that the communication trigger command is not received in the step S21, the sequence of the step S21 is repeated until it is determined that the communication trigger command is received.

When it is determined that the communication trigger command is received in the step S21, the controller 81 transmits a response signal corresponding to the communication trigger command to the entrance administration equipment 1 through the modulator 82 and the resonance circuit 85 in a step S22.

In a step S23, the controller 81 determines on the basis of signal entered by the demodulator 83 whether the transmitting command of the embarkation person information transmitted by the entrance administration equipment 1 in the step S5 of FIG. 6 is received or not. When it is determined that the transmitting command of the embarkation person information is not received in the step S23, the sequence of the step S23 is repeated until it is determined that the transmission command of the embarkation person information is received.

When it is determined that the transmitting command of the embarkation person information is received in the step S23, the controller 81 reads out embarkation person information from the storage section 81A to be transmitted to the entrance administration equipment 1 through the modulator 82 and the resonance circuit 85 in a step S24.

In a step S25, the controller 81 determines on the basis of a signal entered by the demodulator 83 whether the control signal for cutting the power supply of the portable telephone 21 transmitted by the entrance administration equipment 1 in the step S13 of FIG. 6 is received or not.

When it is determined that the control signal for cutting the power of the portable telephone 21 is not received in the step S25, the operation ends. Then, if the entrance administration equipment 1 is designed to transmit to the portable telephone 21 a signal corresponding to an error message representing a failure of the authentication, the controller 81 outputs a signal corresponding to the error message entered by the demodulator 83 to be applied to the main controller 61. Then, the main controller 61 may output the error message to be applied to the display 71 through the bus 62 to be displayed.

When it is determined that the control signal for cutting the power supply is received in the step S25, the controller 81 controls the power supply control unit 21C based on the received control signal to cut the power supply which is supplied to the call unit 21A in a step S26, and the sequence finishes.

When the portable telephone 21 has a function other than the communicator function and the control signal transmitted by the entrance administration equipment 1 is the control signal for cutting the power supply the portable telephone 21, the controller 81 controls the power unit 21C based on the received control signal to cut the power supply which is supplied to the call unit 21A but not to cut power of any other function (not shown in drawings).

Thus, the entrance administration equipment 1 installed in an entrance gate at an embarkation entrance of an airport is designed to communicate with the portable telephone 21 for mutual communication of information, thereby executing an entrance process. When a passenger is granted access and passes the entrance administration equipment 1, the power of the portable telephone 21 is automatically cut, but the information such as a seat number, necessary after cutting the power of the portable telephone 21, is printed on a media such as a predetermined paper, so that the passenger is free from reactivating the power of the portable telephone 21 inside of the entrance administration equipment 1.

This invention can also be applied to an entrance administration equipment installed in a wicket of a railway, an entrance of a concert hall, a movie theater, a hospital or a meeting room, or applied as an exit administration equipment for such facilities.

Although the embarkation person information stored beforehand in the portable telephone 21 is printed on the ticket 60 in this embodiment, it can be printed on other media such as plastic card than the media made of paper.

Even though the communication of information between the entrance administration equipment 1 and the portable telephone 21 is executed by electromagnetic waves in this embodiment, it may be executed by employing electric contact terminals for mutual communication there between with electric contact.

Additionally, the device for communicating with the entrance administration equipment 1 is represented by the portable telephone 21 in this embodiment, but may be represented by other communication terminal such as a PHS (Personal Handy Phone System), a PDA (Personal Digital (Data) Assistants) or the like.

The system described in this specification represents a whole facility composed of a plurality of devices.

According to the entrance administration equipment of this invention, the information stored in the portable communication terminal, which is necessary after cutting the power of the portable communication terminal can be printed on a predetermined media, so that the information necessary after passing the entrance administration equipment does not need to be taken from the portable communication terminal.

According to the entrance managerial system of this invention, an entrance process can be executed by communicating information between the entrance administration equipment and the portable communication terminal. As a user inside of an area utilizing the entrance administration equipment, the power of the portable communication terminal can be automatically cut, and the information stored in the portable communication terminal which is necessary after cutting the power of the portable communication terminal can be printed on a predetermined media, so that the information necessary after passing the entrance administration equipment does not need to be taken from the portable communication terminal later.

While this invention has been described and illustrated with respect to certain embodiments which give satisfactory results, it will be understood by those skilled in the art, after understanding the purpose of the invention, that various other changes and modifications may be made without departing from the spirit and scope of the invention, and it is therefore, intended in the appended claims to cover all such changes and modifications.

What is claimed as new and desired to be protected by Letters Patent of the United States is:

1. An entrance administration equipment, comprising:
a first transmitter for transmitting a transmission command of first information representing visitor information to a portable communication terminal;
a receiver for receiving said first information from said portable communication terminal;
a determining unit for determining based on said first information received by said receiver whether or not a user carrying said portable communication terminal is allowed to enter;
a printer for printing second information on a predetermined media based on the first information received by said receiver when said determining unit determines that said used is allowed to enter; and
a second transmitter for transmitting to said portable communication terminal a control signal for cutting power of said portable communication terminal.

2. An entrance administration equipment according to claim 1, in which said second information includes information necessary after cutting the power of said portable communication terminal which is included in said first information.

3. An entrance administration equipment according to claim 1, in which said first and second information includes a seat number.

4. An entrance administration equipment according to claim 1, in which said predetermined media is a predetermined media made of paper.

5. An entrance administration equipment according to claim 1, further comprising a notifying unit for notifying that said user is not allowed to enter.

6. An entrance administration equipment according to claim 5, in which said notifying unit notifies that said user is not allowed to enter by displaying a message that said user is not allowed to enter.

7. An entrance administration equipment according to claim 5, in which said notifying unit notifies that said user is not allowed to enter by outputting a voice signal that said user is not allowed to enter.

8. An entrance administration equipment according to claim 5, in which said notifying unit notifies that said user is not allowed to enter by activating or deactivating a predetermined light emitting diode when said user is not allowed to enter.

9. An entrance administration equipment according to claim 1, further comprising a controlling unit for controlling opening and closing of a door to limit passing of said user, in which said controlling unit controls opening and closing of said door based on determination results by said determining unit.

10. An entrance administration equipment according to claim 1, further comprising a storing unit for storing information with respect to said user who is allowed to enter, in which said determining unit refers to information with respect to said user stored by said storing unit and determines whether or not said user carrying said portable communication terminal is allowed to enter.

11. An entrance administration equipment according to claim 1, further comprising a recording unit for storing the information of said user who is determined to enter by said determining unit.

12. An entrance administration equipment according to claim 1, in which said control signal for cutting power of said portable communication terminal is a control signal for cutting power of a communicating function in said portable communication terminal.

13. An entrance administration system including an entrance administration equipment installed at an entrance to be entered by a user to a predetermined location and a portable communication terminal carried by said user, said entrance administration equipment, comprising:
a first transmitter for transmitting a transmission command of first information representing visitor information to a portable communication terminal;
a first received for receiving said first information from said portable communication terminal;
a determining unit for determining based on said first information received by said first receiver whether or not said user carrying said portable communication terminal is allowed to enter;
a printer for printing second information on a predetermined media based on the first information received by said first receiver when said determining unit determines that said user is allowed to enter; and
a second transmitter for transmitting to said portable communication terminal a control signal for cutting power of said portable communication terminal;
wherein said portable communication terminal, comprising a storing unit for storing said first information, a second receiver for receiving a transmission command of said first information stored in said storing unit from said entrance administration equipment, a third transmitter for transmitting said first information stored in said storing unit, a third receiver for receiving said control signal for controlling the power from said entrance administration equipment, and a controller for controlling the power based on said control signal received by said third receiver.

14. An entrance administrating method comprising:
a first transmitting step of transmitting a transmission command of first information representing visitor information to a portable communication terminal;
a receiving step of receiving said first information from said portable communication terminal;
a determining step of determining based on said first information received in the said receiving step whether or not a user carrying said portable communication terminal is allowed to enter;
a printer step of printing second information on a predetermined media based on the first information received in said receiving step when it is determined in the determining step that said user is allowed to enter; and
a second transmitting step of transmitting to said portable communication terminal a control signal for cutting power of said portable communication terminal.
